(19) United States
(12) Patent Application Publication
(10) Pub. No.: US 2011/0185167 A1
(43) Pub. Date: Jul. 28, 2011

(54) CHANGE IMPACT RESEARCH SUPPORT DEVICE AND CHANGE IMPACT RESEARCH SUPPORT METHOD

(75) Inventor: Atsuji Sekiguchi, Kawasaki (JP)

(73) Assignee: FUJITSU LIMITED, Kawasaki-shi (JP)

(21) Appl. No.: 13/081,157

(22) Filed: Apr. 6, 2011

Related U.S. Application Data
(63) Continuation of application No. PCT/JP2008/069065, filed on Oct. 21, 2008.

(51) Int. Cl. G06F 9/00

(52) U.S. Cl. 713/100

(57) ABSTRACT

There is provided a change impact research support device. Whenever CI included in configuration management information is modified, CIs modified along with a combination of CIs modified in the present configuration management change are extracted. Then, the more the number of modifications performed along with the combination of the CIs is, the higher impact is set for the extracted CIs, and the CIs are indicated to a user as modification-candidate CIs in descending order of impacts.

### CROSS-REFERENCE TO RELATED APPLICATION

This application is a continuation of International Application No. PCT/2008/069065, filed on Oct. 21, 2008, the entire contents of which are incorporated herein by reference.

### FIELD

The embodiment discussed herein are directed to a change impact research support device and a change impact research support method.

### BACKGROUND

In order to appropriately manage a recent increasingly complex information technology (IT) system, a technique for uniformly managing configuration information of the system by using a database can be employed. Such a database is referred to as a configuration management database (hereinafter, “CMDB”). For example, CMDB as explained in Information Technology Infrastructure Library (ITIL) corresponds to the database.

The CMDB stores therein a configuration item (hereinafter, “CI”) and relationship information between CIs. The CI is provided for each element that constitutes a system such as a server, a router, and an application and specifically includes information such as a node name, an IP address, and an application name.

When performing configuration management by using the CMDB, a worker such as a system manager modifies CI when the configuration or information of a system is changed. At this time, the worker researches whether another CI should be modified in accordance with the modified CI by using relationship information and researches specific modification content for the other CI. Hereinafter, such a research is referred to as “impact research”.

Because the number of elements that constitutes a system is generally enormous, the number of CIs stored in the CMDB is enormous and the number of CIs associated with one CI is also enormous. Therefore, whenever CI is modified, a worker extracts an enormous number of CIs and research whether the enormous number of CIs should be modified. This results in increasing costs of an impact research performed by the worker.

There has been known a technique for indicating modules associated with modules that constitutes software to a user when the software constituting modules are modified, in which this technique is not a technique on an impact research in configuration management. Specifically, according to this technique, when modification is performed on a plurality of modules, related information that indicates relationship between the modules is generated. When a predetermined module is modified, modules are indicated to the user in sequence from a module of which the number of changes is large when the modified module is together modified on the basis of the related information.

When using the technique for configuration management, it is considered that costs of an impact research can be slightly reduced. However, the conventional art has a problem in that costs of an impact research cannot be sufficiently reduced. Specifically, the number of CIs required for configuration management is much more than the number of modules that constitute software. Therefore, because an enormous number of CIs associated with the modified CI are extracted even if the conventional art is used, costs of an impact research cannot be sufficiently reduced.

Patent Document: Japanese Laid-open Patent Publication No. 2006-178511

### SUMMARY

According to an aspect of an embodiment of the invention, a change impact research support device supports a configuration management change that is a change to configuration management information including a plurality of constituent elements. The change impact research support device includes an impact relationship information storage unit that stores therein, for each already-processed change that is a configuration management change performed on the configuration management information in past times, a combination of constituent elements modified in the already-processed change; an extracting unit that extracts, based on a combination of already-modified constituent elements that are constituent elements that are already modified in a present configuration management change that is a configuration management change that is presently performed whenever the constituent element of the configuration management information is modified, already-processed changes similar to the present configuration management change from the impact relationship information storage unit; and a modification-candidate selecting unit that computes, for each constituent element that is not yet modified in the present configuration management change, an impact that is a cumulative total of already-processed changes in which the constituent element is modified among the already-processed changes extracted by the extracting unit, and selects a constituent element that is a modification candidate by using the computed impact.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a diagram illustrating an example of a communication system that includes a change impact research support device according to a first embodiment;

FIG. 2 is a flowchart illustrating CI modification procedures of a configuration management DB that are generally performed by a user;

FIG. 3 is a diagram illustrating the configuration of the change impact research support device and a configuration management server according to the first embodiment;

FIG. 4A is a diagram illustrating an example of impact relationship information;

FIG. 4B is a diagram illustrating an example of the impact relationship information;

FIG. 5A is a diagram illustrating an example of the impact information;

FIG. 5B is a diagram illustrating an example of the impact information;

FIG. 5C is a diagram illustrating an example of the impact information;

FIG. 5D is a diagram illustrating an example of the impact information;

FIG. 5E is a diagram illustrating an example of the impact information;

FIG. 6 is a diagram illustrating an example of a modification candidate screen that is displayed by an impact evaluating unit illustrated in FIG. 3;

FIG. 7 is a flowchart illustrating change impact research support processing procedures that are performed by the change impact research support device according to the first embodiment;

FIG. 8 is a diagram illustrating an example of the impact information;

FIG. 9 is a diagram illustrating the configuration of a change impact research support device according to a second embodiment;

FIG. 10A is a diagram illustrating an example of impact information;

FIG. 10B is a diagram illustrating an example of the impact information;

FIG. 10C is a diagram illustrating an example of the impact information;

FIG. 11 is a diagram illustrating an example of group impact information;

FIG. 12 is a diagram illustrating an example of an evaluated value table;

FIG. 13 is a diagram illustrating an example of a modification candidate screen that is display-controlled by an impact evaluating unit illustrated in FIG. 9;

FIG. 14 is a flowchart illustrating change impact research support processing procedures that are performed by the change impact research support device according to the second embodiment; and

FIG. 15 is a diagram illustrating a computer that performs a change impact research support program.

### DESCRIPTION OF EMBODIMENTS

Preferred embodiments of the present invention will be explained with reference to accompanying drawings. A change impact research support program, a change impact research support device, and a change impact research support method according to the present invention are not limited to the embodiments explained below.

### [a] First Embodiment

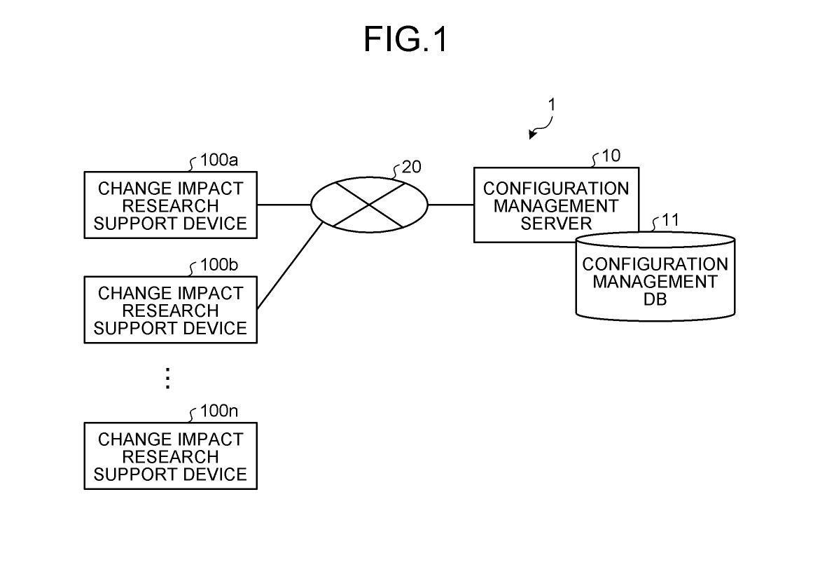

First, it will be explained about a communication network that includes a change impact research support device according to the first embodiment. FIG. 1 is a diagram illustrating an example of a communication system 1 that includes a change impact research support device 100 according to the first embodiment. As illustrated in FIG. 1, the communication system 1 includes a configuration management server 10 and change impact research support devices 100a to 100n that are connected via a network 20.

The configuration management server 10 is a server that holds information on configuration management and includes a configuration management DB 11. The configuration management DB is, for example, CMDB, and stores therein relationship information between CI and CI. The CI and relationship information are manually stored by a user in the configuration management DB or are automatically collected by a system and are stored in the configuration management DB.

The change impact research support devices 100a to 100n are devices that support the modification of CIs that are stored in the configuration management DB. For example, the change impact research support device corresponds to a personal computer. Moreover, when one of the change impact research support devices 100a to 100n does not need to be specified in the following descriptions, they are generally referred to as the change impact research support device 100.

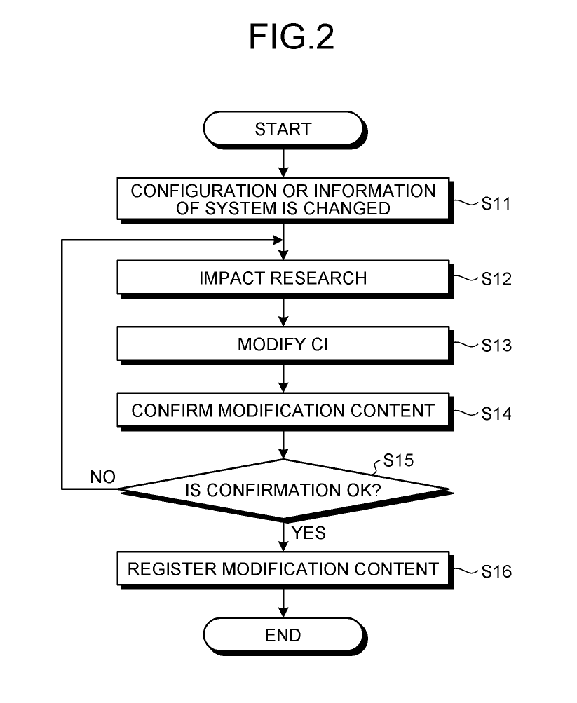

In this case, in order to facilitate the descriptions of the change impact research support device 100 according to the first embodiment, it will be explained about working procedures that are generally performed by a user when CI of the configuration management DB is modified. FIG. 2 is a flowchart illustrating CI modification procedures of the configuration management DB that are generally performed by a user.

As illustrated in FIG. 2, when the configuration or information of a system is changed (Step S11), a worker such as a system manager performs an impact research (Step S12). Moreover, as an example where the configuration or information of a system is changed, there is a case where a Web server is added to an IT system or a case where a patch is applied to a predetermined program.

At this time, a user once makes a predetermined storage area store a part or the whole of CIs and relationship information of the configuration management DB. The term “predetermined storage area” is a storage area that temporarily stores information and is a storage device that is included in a personal computer handled by a user. Hereinafter, the predetermined storage area is referred to as “temporary storage”.

Next, the user researches whether another CI should be modified in accordance with the modification of CI that is a modification target, in addition to the CI that is a modification target. Then, the user modifies the CI that is a modification target and the other CI that is determined to be modified, with respect to CIs stored in the temporary storage (Step S13).

Next, the user confirms the modification result of CI (Step S14). When a modification content does not have a problem (Step S15: YES), the user reflects the already-modified CIs stored in the temporary storage on the configuration management DB (Step S16).

It will be explained about a reason that CIs of the configuration management DB are stored in the temporary storage and then are modified, and the modified CIs are reflected on the configuration management DB. This reason is that sequential updating of CIs stored in the configuration management DB may lose consistency between CIs during updating. Because it is preferable that consistency between CIs stored in the configuration management DB be always maintained, consistency between CIs is maintained by storing CIs in the temporary storage and reflecting the modified CIs on the configuration management DB in a mass.

Hereinafter, it is assumed that a process for storing CIs of the configuration management DB in the temporary storage, modifying the CIs, and reflecting the modified CIs on the configuration management DB is referred to as “configuration management change”. In other words, one configuration management change may modify one or more CIs.

However, because the number of elements that constitutes a system is enormous as described above, the number of CIs stored in CMDB is also enormous and the number of CIs associated with one CI is further enormous. Therefore, whenever CI is modified, the worker performs an impact research on an enormous number of CIs. This causes the increase of costs of an impact research performed by the worker.

Therefore, whenever CI is modified, the change impact research support device 100 according to the first embodiment indicates another candidate CI (hereinafter, “modification-candidate CI”) to be modified to a user by using information on the configuration management change performed in past times. Moreover, the term “information on the configuration management change performed in past times” indicates a combination of CIs modified in the configuration management change for each configuration management change performed in past times. Hereinafter, information on a configuration management change performed in past times is referred to as “impact relationship information”.

Specifically, whenever CI is modified, the change impact research support device 100 extracts another CI that has been modified along with the combination of CIs that are modified in the presently-performed configuration management change (hereinafter, “present configuration management change”). The change impact research support device 100 then indicates the extracted CI to the user as a modification-candidate CI.

As a more specific explanation, whenever CI is modified, the change impact research support device 100 extracts the past configuration management change including a combination of all CIs modified in the present configuration management change from impact relationship information. Next, the change impact research support device 100 computes, for each CI that is not yet modified in the present configuration management change, a cumulative total of configuration management changes, in which this CI is modified, among the extracted configuration management changes. The change impact research support device 100 then indicates CIs to the user in descending order of cumulative total values. Hereinafter, such a cumulative total value is referred to as “impact”.

In this way, whenever CI is modified, the change impact research support device 100 according to the first embodiment extracts the past configuration management change from the impact relationship information on the basis of the combination of CIs modified in the present configuration management change. Then, the change impact research support device 100 indicates CIs to the user in descending order of impacts from the extracted past configuration management changes. As a result, because the change impact research support device 100 can indicate a modification-candidate CI to the user on the basis of the past configuration management changes, costs of an impact research performed by the user can be reduced.

The more CIs are modified, the further the change impact research support device 100 can narrow down and extract the past configuration management changes. In other words, because the more CIs are modified, the fewer the change impact research support device 100 can select a modification-candidate CI from configuration management changes, the change impact research support device 100 can decrease the number of modification-candidate CIs to be indicated to the user.

As described above, the change impact research support device 100 can sufficiently reduce costs of an impact research.

Next, it will be more specifically explained about the change impact research support device 100 described above. It will be sequentially explained about the configurations of the change impact research support device 100 and the configuration management server 10 according to the first embodiment and the procedures of a change impact research support process performed by the change impact research support device 100 according to the first embodiment.

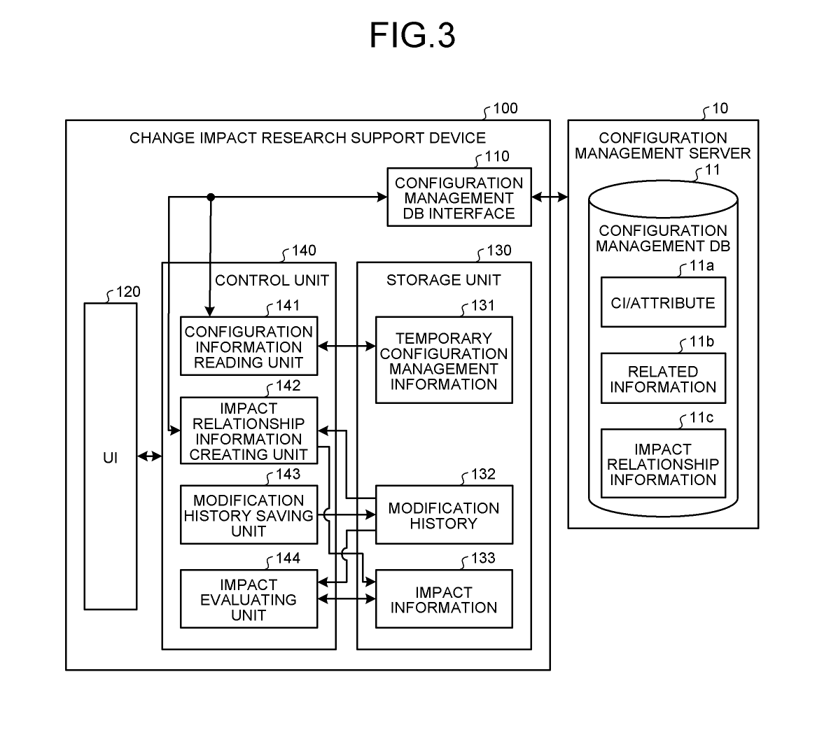

First, it will be explained about the configuration of the change impact research support device 100 and the configuration management server 10 according to the first embodiment. FIG. 3 is a diagram illustrating the configuration of the change impact research support device 100 and the configuration management server 10 according to the first embodiment.

As illustrated in FIG. 3, the configuration management server 10 includes the configuration management DB 11. The configuration management DB 11 includes a CI/attribute (hereinafter, “CI”) 11a, a related information 11b, and an impact relationship information 11c. As described above, the CI 11a stores therein a plurality of CIs that forms a predetermined IT system. The CI DB has one or more attributes such as a CI name, a node name, an IP address, and an application name and holds specific information on the attributes.

For example, the CI 11a stores, as information on a Web server, information such as, for example, a CI name “Web 1”, a node name “Web server A”, and an IP address “X.X.X.X” as one CI. Moreover, the CI 11a stores, as information on an application server, information such as, for example, a CI name “AP1”, a node name “application server B”, an IP address “Y.Y.Y.Y”, and an application name “Test.pl” as one CI.

The related information 11b stores therein relationship information between CIs that are stored in the CI 11a. For example, the related information 11b stores information, which there is communication relationship between a Web server and an application server, in the form of a directed graph, an undirected graph, or the like.

As described above, the impact relationship information 11c stores therein information on configuration management changes performed on the configuration management DB 11 in past times. Specifically, the impact relationship information 11c stores, for each configuration management change performed in past times, a combination of CIs modified in the configuration management changes.

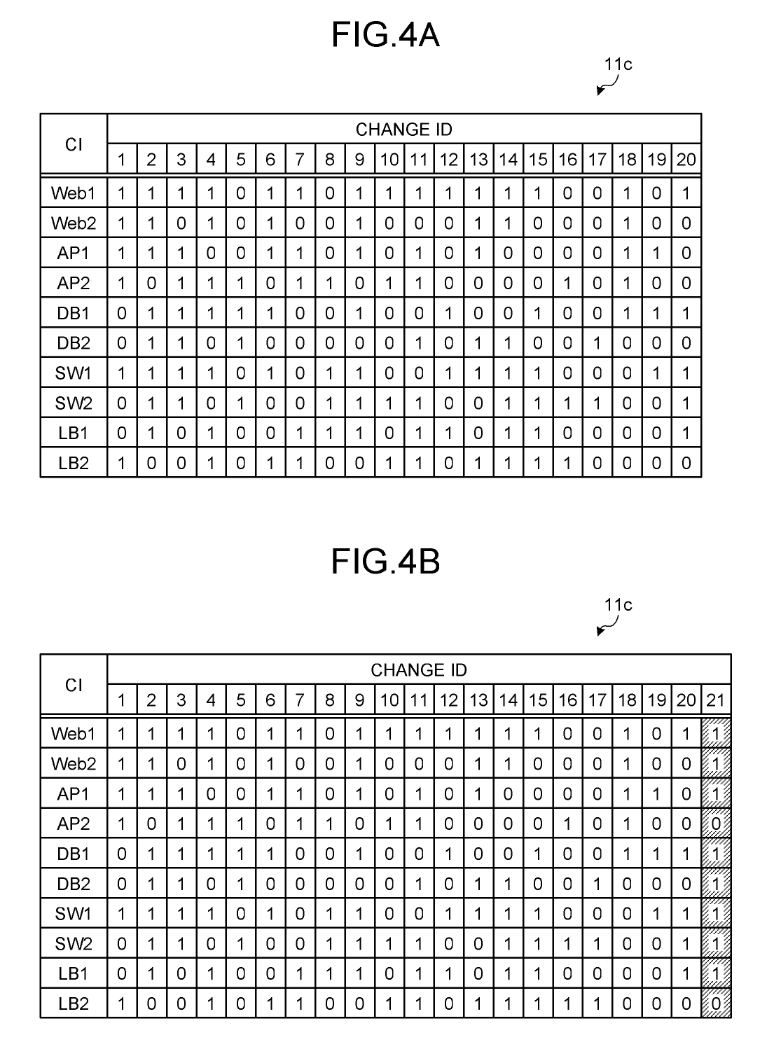

In this case, an example of the impact relationship information 11c is illustrated in FIG. 4A. As illustrated in FIG. 4A, the impact relationship information 11c has items such as a CI and a change ID. The “CI” corresponds to the CI name of CI stored in the CI 11a.

The “change ID” is an identification number for identifying a past configuration management change. In the example illustrated in FIG. 4A, the change ID indicates that the smaller its value is, the more past times the configuration management change is performed. Moreover, in the example illustrated in FIG. 4A, it is assumed that the impact relationship information DB 11c stores “1” for CI that is modified in a predetermined configuration management change and stores “0” for CI that is not modified.

In other words, the impact relationship information 11c illustrated in FIG. 4A indicates that the number of configuration management changes performed on the configuration management DB 11 in past times is 20. Moreover, in FIG. 4A, a configuration management change indicated by the change ID “1” indicates that it is a configuration management change performed in most past times. Moreover, in FIG. 4A, a configuration management change indicated by a change ID “1” indicates that CIs “Web1”, “Web2”, “AP1”, “AP2”, “SW1”, and “LB2” are modified. Moreover, in the CIs illustrated in FIG. 4A, Web indicates a Web server, AP indicates an application, DB indicates a database, SW indicates switches such as layer 2 to layer 4, and LB indicates a load balance.

In this way, the impact relationship information 11c stores, for each configuration management change performed in past times, a combination of CIs that are modified in the configuration management changes. In other words, the change impact research support device 100 can refer to various types of information stored in the impact relationship information 11c to recognize CIs that are simultaneously modified in the configuration management changes performed in past times.

Returning to FIG. 3, the change impact research support device 100 includes a configuration management DB interface 110 (hereinafter, “configuration management DB I/F”), a user interface (hereinafter, “UI”) 120, a storage unit 130, and a control unit 140.

The configuration management DB I/F 110 is an interface that transmits and receives various types of information to and from the configuration management server 10 via the network 20. Specifically, the configuration management DB I/F 110 receives the CI 11a, the related information 11b, and the impact relationship information 11c stored in the configuration management DB 11 from the configuration management server 10, and transmits the modified CI to the configuration management server 10.

The UI 120 is an interface that exchanges various types of information between the change impact research support device 100 and a user. Specifically, the UI 120 corresponds to an input unit (for example, keyboard or mouse) that receives predetermined information from the user and a display unit (for example, liquid crystal display) that displays predetermined information to the user.

The storage unit 130 is a storage device that stores therein various types of information, and includes a temporary configuration management information 131, a modification history 132, and an impact information 133. The temporary configuration management information 131 indicates information that is stored in the temporary storage described above, and stores the CI 11a and the impact relationship information 11c that are stored in the configuration management DB 11.

The modification history 132 stores log information on the present configuration management change. Specifically, the modification history 132 stores a CI name of CI modified in the present configuration management change and information on date and time at which the CI is modified.

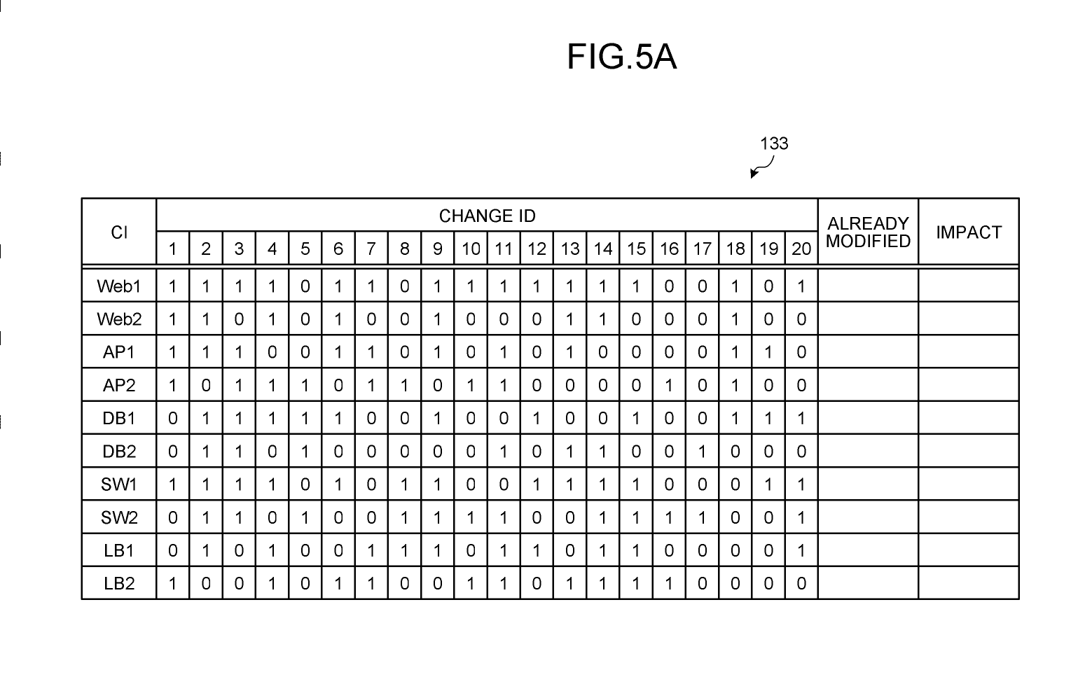

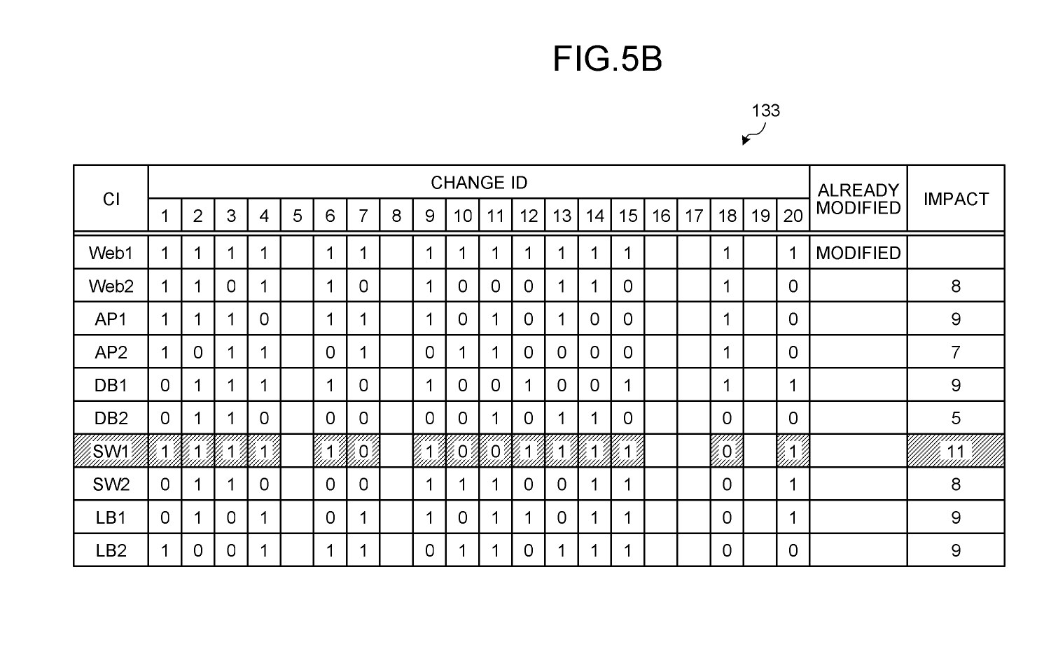

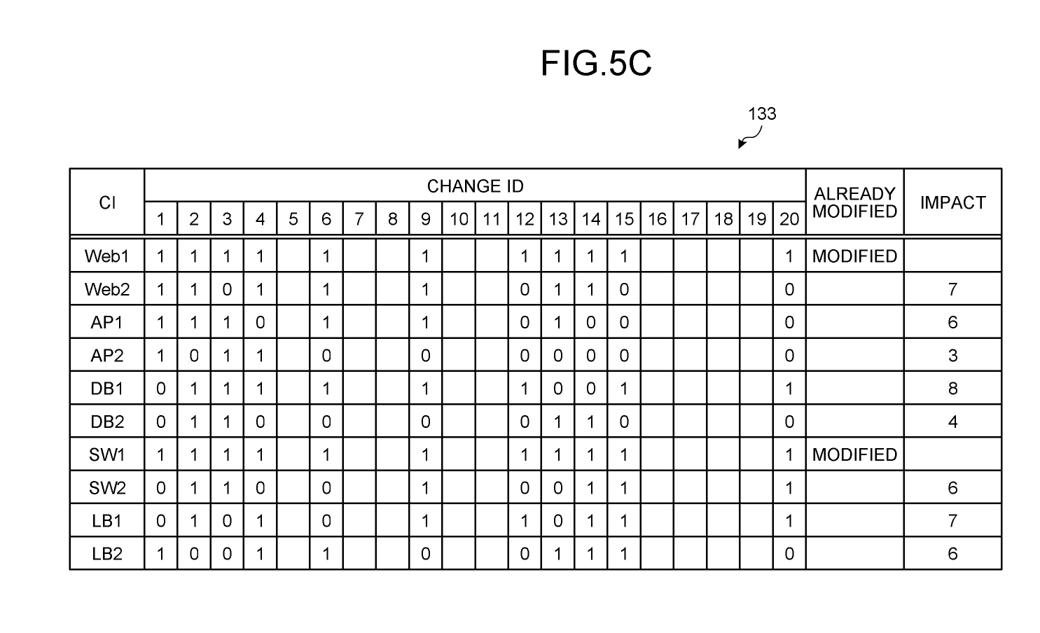

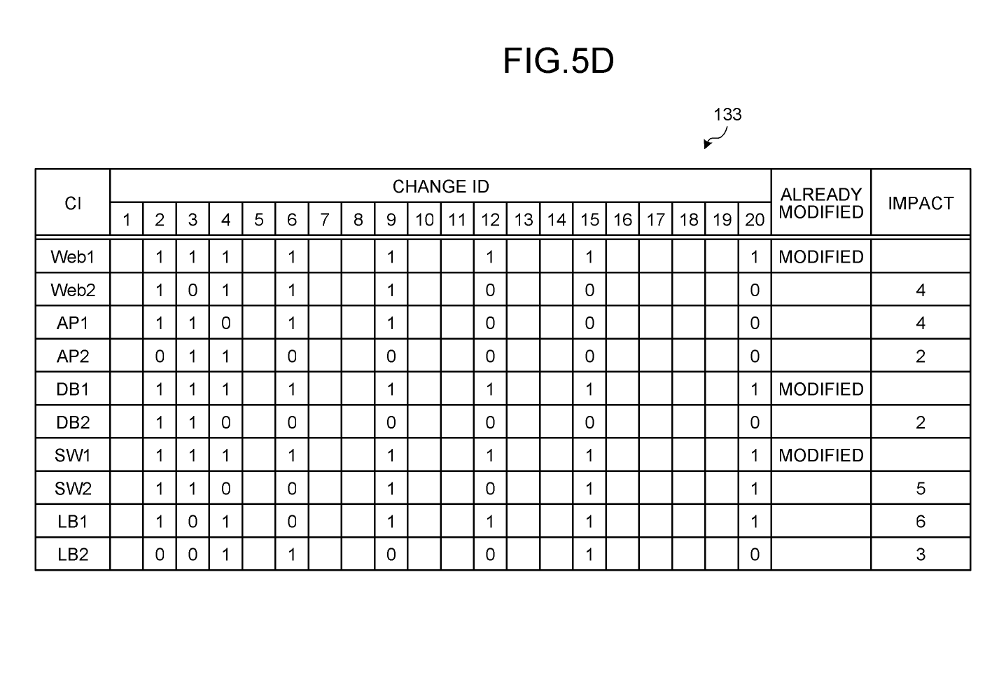

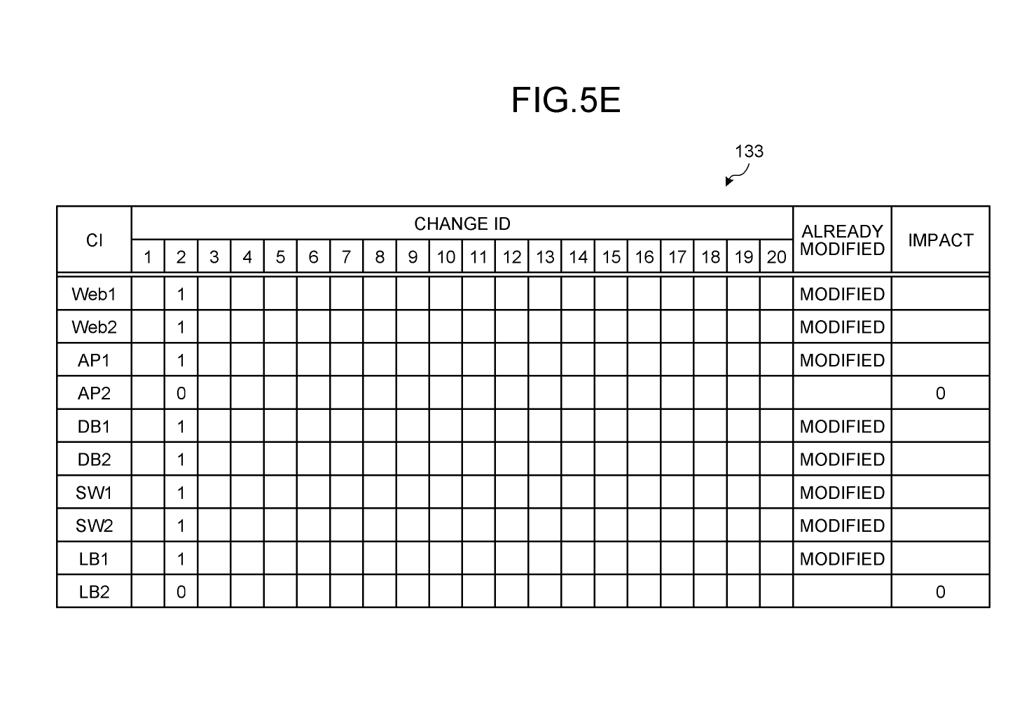

The impact information 133 stores an impact of the combination of the already modified CIs to the CIs that are not yet modified in the present configuration management change. An example of the impact information 133 is illustrated in FIG. 5A. As illustrated in FIG. 5A, the impact information 133 has items such as, for example, a CI, a change ID, already-modified, and an impact. The “CI” corresponds to the CI illustrated in FIG. 4A and the “change ID” corresponds to the change ID illustrated in FIG. 4A. The “already-modified” indicates information indicating whether CI is modified in the present configuration management change. The “impact” stores, for each CI that is not modified in the present configuration management change, a cumulative total of configuration management changes in which the CIs are modified. It will be explained in detail about the impact information 133 when a process performed by the control unit 140 is explained.

The control unit 140 totally controls the change impact research support device 100, and includes a configuration information reading unit 141, an impact relationship information creating unit 142, a modification history saving unit 143, and an impact evaluating unit 144 as processing units for a change impact research support process according to the first embodiment.

The configuration information reading unit 141 receives information stored in the CI 11a of the configuration management DB 11 from the configuration management server 10 and transmits information of the modified CI to the configuration management server 10.

Specifically, when an operation of starting a configuration management change is performed by the user by using the UI 120, the configuration information reading unit 141 receives information stored in the CI 11a of the configuration management DB 11 from the configuration management server 10 via the configuration management DB I/F 110. Then, the configuration information reading unit 141 makes the temporary configuration management information 131 store the received information stored in the CI 11a. The user that uses the change impact research support device 100 modifies the CI stored in the temporary configuration management information 131 by using the UI 120.

Moreover, when an operation of stopping the configuration management change is performed by the user by using the UI 120, the configuration information reading unit 141 transmits the already-modified CI information stored in the temporary configuration management information 131 to the configuration management server 10 via the configuration management DB I/F 110. The configuration management server 10 reflects the received already-modified CI information on the CI 11a.

The impact relationship information creating unit 142 receives information stored in the impact relationship information 11c of the configuration management DB 11 from the configuration management server 10 and transmits an item name of the modified CI to the configuration management server 10.

Specifically, when an operation of starting the configuration management change is performed by the user, the impact relationship information creating unit 142 receives information stored in the impact relationship information 11c of the configuration management DB 11 from the configuration management server 10 via the configuration management DB I/F 110. Then, the impact relationship information creating unit 142 makes the impact information 133 store the received information stored in the impact relationship information 11c.

Moreover, when an operation of stopping the configuration management change is performed by the user, the impact relationship information creating unit 142 transmits the CI name of the already-modified CI stored in the modification history 132 to the configuration management server 10 via the configuration management DB I/F 110. The configuration management server 10 updates the impact relationship information DB 11c of the configuration management DB 11 on the basis of the received CI name.

Now, it will be specifically explained about an updating process of the impact relationship information 11c that is performed by the configuration management server 10. For example, it is assumed that the configuration management server 10 receives information, which indicates the effect that CI names “Web1”, “Web2”, “AP1”, “DB1”, “DB2”, “SW1”, “SW2”, and “LB1” are modified, from the impact relationship information creating unit 142. Moreover, it is assumed that the impact relationship information DB 11c is in the state illustrated in FIG. 4A.

In this case, the configuration management server 10 appends a row of a change ID “21”, which is obtained by adding “1” to the maximum value “20” of the change ID, to the impact relationship information creating unit 142. Then, as indicated by a slant line in FIG. 4B, the configuration management server 10 stores “1” for the CIs “Web1”, “Web2”, “AP1”, “DB1”, “DB2”, “SW1”, “SW2”, and “LB1” and stores “0” for the other CIs “AP2” and “LB2”, in the appended row.

As a result, the configuration management server 10 can make the impact relationship information 11c store the configuration management changes performed by the change impact research support device 100. In other words, when a configuration management change is performed from now, the configuration management changes performed by the change impact research support device 100 can be used as the past configuration management changes.

Whenever the CI stored in the temporary configuration management information 131 is modified, the modification history saving unit 143 makes the modification history 132 store the CI name and the like of the modified CI. For example, when the IP address of the CI “Web1” is modified by the user among the CIs stored in the temporary configuration management information 131, the modification history saving unit 143 makes the modification history 132 store the CI name “Web1” and the date and time at which the CI “Web1” is modified. Moreover, although the modification history saving unit 143 may make the modification history 132 store any log information, the modification history saving unit 143 makes it store at least the CI name of the modified CI.

Whenever the CI stored in the temporary configuration management information 131 is modified, the impact evaluating unit 144 updates the impact information 133 and indicates a modification-candidate CI to the user on the basis of the updated information stored in the impact information 133. Specifically, whenever the CI name of the modified CI is stored in the modification history 132, the impact evaluating unit 144 extracts the past configuration management change in which the CI is modified from the impact information 133. Then, the impact evaluating unit 144 computes an impact for each CI for the extracted past configuration management change.

Now, it will be explained by using an example about a modification-candidate CI indicating process that is performed by the impact evaluating unit 144. In this case, it is assumed that the impact information 133 when any CI is not modified in the configuration management change is in a state illustrated in FIG. 5A. In this state, it is assumed that a predetermined attribute of the CI “Web1” is first modified by the user.

In this case, the impact evaluating unit 144 extracts a configuration management change in which the CI “Web1” is modified among the configuration management changes performed in past times. Specifically, the impact evaluating unit 144 extracts configuration management changes indicated by the change IDs “1” to “4”, “6”, “7”, “9” to “15”, “18”, and “20” for which information corresponding to the CI “Web1” in the impact information 133 illustrated in FIG. 5A has “1”.

In the present specification, in order to make an explanation understandable, it is assumed to empty information stored in the configuration management change that is not extracted. In other words, the impact evaluating unit 144 empties information stored in the change IDs “5”, “8”, “16”, “17”, and “19” for which information corresponding to the CI “Web1” has “0”. As a result, the impact information 133 is changed into a state illustrated in FIG. 5B. Actually, it is not necessary to perform a process for emptying information.

Next, as illustrated in FIG. 5B, the impact evaluating unit 144 stores “modified” in an item “already-modified” of the impact information 133 corresponding to the CI “Web1”. Next, as illustrated in FIG. 5B, the impact evaluating unit 144 computes, for each CI other than the already-modified CI “Web1”, an impact that is a cumulative total of the configuration management changes in which the CI is modified.

Specifically, as illustrated in the impact information 133 of FIG. 5B, the CI “Web2” is modified in eight configuration management changes that are indicated by the change IDs “1”, “2”, “4”, “6”, “9”, “13”, “14”, and “18”. Therefore, the impact evaluating unit 144 stores “8” in an item “impact” of the impact information 133 corresponding to the CI “Web2”.

As illustrated in the impact information 133 of FIG. 5B, the CI “AP1” is modified in nine configuration management changes that are indicated by the change IDs “1”, “2”, “3”, “6”, “7”, “9”, “11”, “13”, and “18”. Therefore, the impact evaluating unit 144 stores “9” in an item “impact” of the impact information 133 corresponding to the CI “AP1”.

Similarly, the impact evaluating unit 144 computes an item “impact” corresponding to the CIs “AP2” to “LB2” and stores the results in the impact information 133. The impact computed in this way indicates the number of times by which the CIs are modified at the same time as the CI “AP1” in past times. Therefore, when the CI “AP1” is modified, an impact indicates another CI that is easily modified simultaneously.

After computing the impact in this way, the impact evaluating unit 144 generates a list of modification-candidate CIs to be indicated to the user. Specifically, the impact evaluating unit 144 generates a list of modification-candidate CIs in descending order of the computed impacts as CI that is easily modified at the same time as the CI “AP1”. Then, as indicated by a slant line of FIG. 5B, because the impact of the CI “SW1” is the largest, the impact evaluating unit 144 controls the display of the display unit in such a manner that the user can understand that the impact of the CI “SW1” is the largest. Moreover, the impact evaluating unit 144 controls the display of the display unit in such a manner that the user can understand that the impacts of the CIs “AP1”, “DB1”, “LB1”, and “LB2” are secondly large. As a result, the user can recognize CI that is easily modified at the same time as the CI “Web1” at the point at which the CI “Web1” is modified.

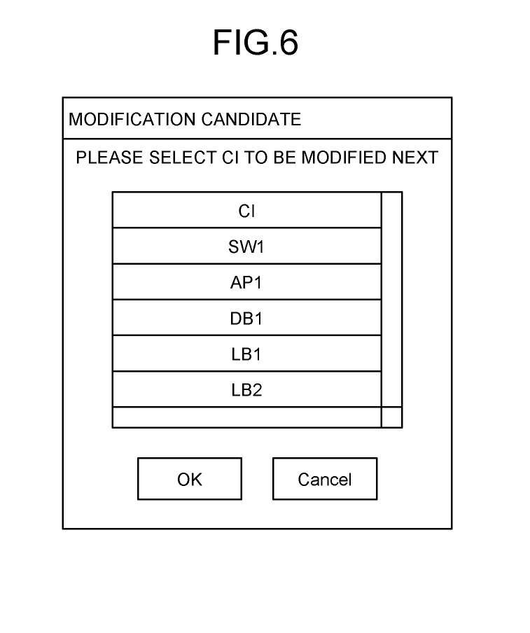

Now, an example of a modification candidate screen that is displayed by the impact evaluating unit 144 illustrated in FIG. 3 is illustrated in FIG. 6. In an example illustrated in FIG. 6, the impact evaluating unit 144 controls the display of the modification-candidate CI on the display unit in such a manner that the larger an impact of the CI, the upper position the IC is displayed on the modification candidate screen. In the modification candidate screen illustrated in FIG. 6, the user can modify the selected CI information by selecting CI and clicking an “OK” button by using a mouse or the like.

Next, it is assumed that the CI “SW1” is modified by the user. In this case, the impact evaluating unit 144 extracts configuration management changes in which the CIs “Web1” and “SW1” are modified, among the configuration management changes performed in past times. Specifically, the impact evaluating unit 144 extracts configuration management changes indicated by the change IDs “1” to “4”, “6”, “9”, “12” to “15”, and “20” for which information corresponding to the CI “SW1” in the impact information 133 illustrated in FIG. 5B has “1”. In other words, as a result, the impact information 133 is changed into a state illustrated in FIG. 5C.

Next, as illustrated in FIG. 5C, the impact evaluating unit 144 stores “modified” in an item “already-modified” of the impact information 133 corresponding to the CI “SW1”. Next, as illustrated in FIG. 5C, the impact evaluating unit 144 computes, for each CI other than the already-modified CIs “Web1” and “SW1”, an impact that is a cumulative total of the configuration management changes in which the CI is modified.

Specifically, as illustrated in the impact information 133 of FIG. 5C, the CI “Web2” is modified in seven configuration management changes that are indicated by the change IDs “1”, “2”, “4”, “6”, “9”, “13”, and “14”. Therefore, the impact evaluating unit 144 stores “7” in an item “impact” of the impact information 133 corresponding to the CI “Web2”. Similarly, the impact evaluating unit 144 computes an item “impact” corresponding to the CIs “AP1” to “DB2” and “SW2” to “LB2” and stores the results in the impact information 133.

Then, the impact evaluating unit 144 controls the display of CI on the display unit of the UI 120 in descending order of the computed impacts as CI that is easily modified at the same time as the CIs “Web1” and “SW1”. Specifically, the impact evaluating unit 144 controls the display of the display unit in descending order of the impacts of the CIs “DB1”, “Web2”, “LB1”, “AP1”, “SW2”, “LB2”, “DB2”, and “AP2”. As a result, the user can recognize CI that is easily modified at the same time as the combination of the CIs “Web1” and “SW1” at the point at which the CIs “Web1” and “SW1” are modified.

Next, it is assumed that the CI “DB1” is modified by the user. In this case, the impact evaluating unit 144 extracts configuration management changes in which the CIs “Web1”, “SW1”, and “DB1” are modified, among the configuration management changes performed in past times. Specifically, the impact evaluating unit 144 extracts configuration management changes indicated by the change ID for which information corresponding to the CI “DB1” in the impact information 133 illustrated in FIG. 5C has “1”. As a result, the impact information 133 is changed into a state illustrated in FIG. 5D.

Next, as illustrated in FIG. 5D, the impact evaluating unit 144 store “modified” in an item “already-modified” of the impact information 133 corresponding to the CI “DB1”. Next, as illustrated in FIG. 5D, the impact evaluating unit 144 computes, for each CI other than the already-modified CIs “Web1”, “SW1”, and “DB1”, an impact that is a cumulative total of the configuration management changes in which the CI is modified.

Then, the impact evaluating unit 144 controls the display of CI on the display unit of the UI 120 in descending order of the computed impacts as CI that is easily modified at the same time as the CIs “Web1”, “SW1”, and “DB1”. Specifically, the impact evaluating unit 144 controls the display of the display unit in descending order of the impacts of the CIs “LB1”, “SW2”, “Web2”, “AP1”, “LB2”, “AP2”, and “DB2”. As a result, the user can recognize CI that is easily modified at the same time as the combination of the CIs “Web1”, “SW1”, and “DB1” at the point at which the CIs “Web1”, “SW1”, and “DB1” are modified.

In this way, it is assumed that the CIs are modified by the user in order of the CIs “LB1”, “SW2”, “Web2”, “AP1”, and “DB2”. In this case, similarly to the process described above, whenever the CI is modified, the impact evaluating unit 144 updates the impact information 133 and controls the display of CI on the display unit in descending order of impacts. Then, when the CI “DB2” is modified, the impact information 133 updated by the impact evaluating unit 144 is changed into a state illustrated in FIG. 5E.

As illustrated in FIG. 5E, CI of which the impact is not less than “1” does not exist at the point at which the CI “DB2” is modified by the user. This means that CI modified at the same time as the CIs “Web1”, “Web2”, “AP1”, “DB1”, “DB2”, “SW1”, “SW2”, and “LB1” modified by the user does not exist till now in the past configuration management changes. Therefore, the user can determine that another CI may not be modified at the point at which the CI “DB2” is modified.

It has been conventionally researched whether another CI should be modified by a modified CI whenever CI is modified. In other words, in the example, the user performs, for example, an impact research on the other nine CIs at the point at which the CI “Web1” is first modified. Next, the user performs an impact research on the other eight CIs at the point at which the CI “SW1” is modified. For this reason, costs of an impact research for the other CIs are increased.

On the other hand, whenever CI is modified, the change impact research support device 100 according to the first embodiment indicates the user CI that is easily modified at the same time as a combination of CIs modified till now. As a result, whenever the CI is modified, the user does not perform an impact research on other all CIs that are not modified. Furthermore, because modification-candidate CIs can be narrowed down by using the combination of the modified CIs as the modification of CIs advances, the change impact research support device 100 does not make the user perform an impact research on all the CIs. Because of this, the change impact research support device 100 can sufficiently reduce costs of an impact research.

In the example described above, it has been explained about the case where the totaled 10 CIs “Web1” to “LB2” are illustrated. In an actual IT system, the number of CIs may be several thousand, several ten-thousand, or more in many cases. In other words, it has been conventionally explained about the case where an impact research is performed on several thousand, several ten-thousand, or more CIs. However, because a user does not need to perform an impact research on several thousand, several ten-thousand, or more CIs if the change impact research support device 100 is used, costs of the impact research can be reduced.

Now, it is explained about the computation process of an impact described above by using a mathematical expression. First, a function AND( ) for calculating a logical sum of a plurality of items is defined like the following Equation (1).

$$AND ( i , j , k , … ) = \{ \begin{matrix}1 & ( i = j = k … = 1 ) \\ 0 & ( one or more of i , j , k , … is 0 )\end{matrix} \qquad ( 1 )$$

An impact Dᵢ of CIᵢ that is not modified in the present configuration management change after n-time modifications is calculated by the following Equation (2) if a change ID is j (1≦j≦c).

$${D}_{i} = {\sum }_{j = 1}^{c} AND ( {F}_{ij} , {M}_{nj} ) \qquad ( 2 )$$

In Equation (2), “Fᵢⱼ” indicates a value (0 or 1) of a flag in the change IDⱼ for CIᵢ that is not modified in the present configuration management change. Moreover, Mₙⱼ=AND (m₁ⱼ, m₂ⱼ, . . . , mₙⱼ) indicates a logical sum of the flags of the already-modified n CIs group of the change IDⱼ after the n-time modifications. Moreover, “mᵢⱼ” indicates a value (0 or 1) of a flag of the change IDⱼ of the k-th already-modified CIₖ.

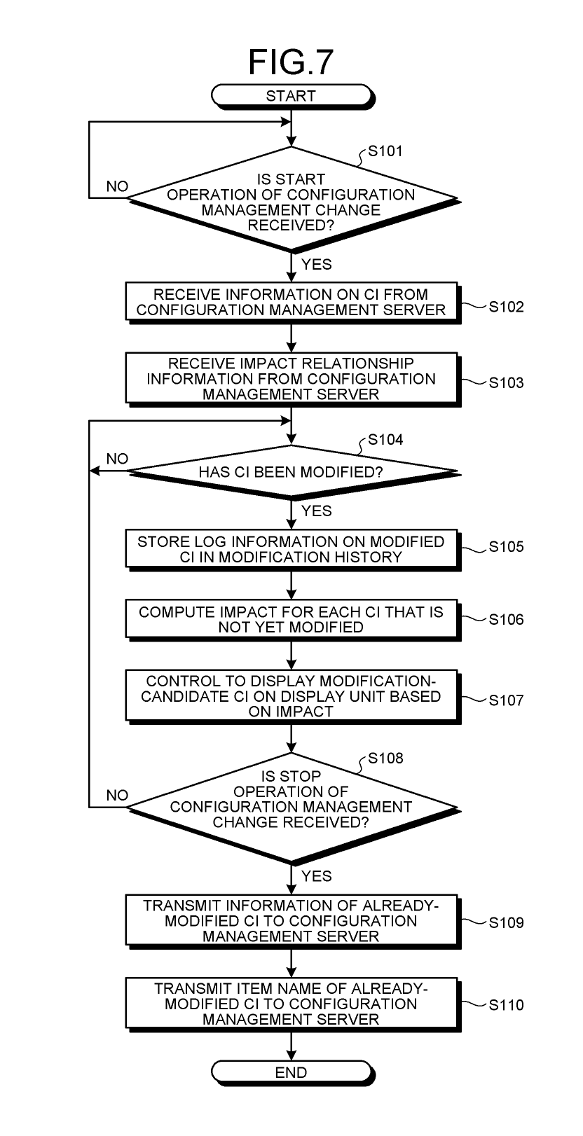

Next, it will be explained about change impact research support processing procedures that are performed by the change impact research support device 100 according to the first embodiment. FIG. 7 is a flowchart illustrating change impact research support processing procedures that are performed by the change impact research support device 100 according to the first embodiment.

As illustrated in FIG. 7, when an operation of starting a configuration management change is performed by the user by using the UI 120 (Step S101: YES), the configuration information reading unit 141 of the change impact research support device 100 receives information stored in the CI DB 11a of the configuration management DB 11 from the configuration management server 10 via the configuration management DB I/F 110 (Step S102). Next, the configuration information reading unit 141 makes the temporary configuration management information 131 store the received information stored in the CI DB 11a.

Next, the impact relationship information creating unit 142 receives information stored in the impact relationship information 11c of the configuration management DB 11 from the configuration management server 10 via the configuration management DB I/F 110 (Step S103). Then, the impact relationship information creating unit 142 makes the impact information 133 store the received information stored in the impact relationship information 11c.

Next, when the CI stored in the temporary configuration management information 131 is modified by using the UI 120 (Step S104: YES), the modification history saving unit 143 makes the modification history 132 store log information (CI name etc.) on the modified CI (Step S105).

Next, the impact evaluating unit 144 updates the impact information 133 and computes an impact for each CI that is not yet modified (Step S106). The impact evaluating unit 144 then controls the display of a modification-candidate CI on the display unit on the basis of the computed impact (Step S107).

While an operation of stopping the configuration management change is not performed by the user by using the UI 120 (Step S108: NO), the modification history saving unit 143 and the impact evaluating unit 144 repeatedly perform the processing procedures described above (Steps S105 to S107) whenever the CI stored in the temporary configuration management information 131 is modified (Step S104: YES).

On the other hand, when the operation of stopping the configuration management change is performed (Step S108: YES), the configuration information reading unit 141 transmits the already-modified CI information stored in the temporary configuration management information 131 to the configuration management server 10 via the configuration management DB I/F 110 (Step S109). As a result, the configuration management server 10 reflects the received already-modified CI information on the CI 11a.

Moreover, the impact relationship information creating unit 142 transmits an item name of the already-modified CI stored in the modification history 132 to the configuration management server 10 via the configuration management DB I/F 110 (Step S110). As a result, the configuration management server 10 updates the impact relationship information 11c of the configuration management DB 11 on the basis of the item name of the received already-modified CI.

As described above, whenever CI is modified, the change impact research support device 100 according to the first embodiment extracts the past configuration management changes from the impact relationship information DB on the basis of the combination of CIs modified in the present configuration management change. Then, the change impact research support device 100 indicates the CIs to the user in descending order of impacts from the extracted past configuration management changes. As a result, because the change impact research support device 100 can indicate a modification-candidate CI to the user, costs of an impact research can be sufficiently reduced.

### [b] Second Embodiment

However, it has been explained about the case where the change impact research support device 100 according to the first embodiment extracts the past configuration management changes modified along with the combination of all the CIs modified in the present configuration management change among the past configuration management changes. Therefore, when a combination of CIs different from the combination of CIs modified in the past configuration management changes is modified, the change impact research support device 100 does not extract a past configuration management change.

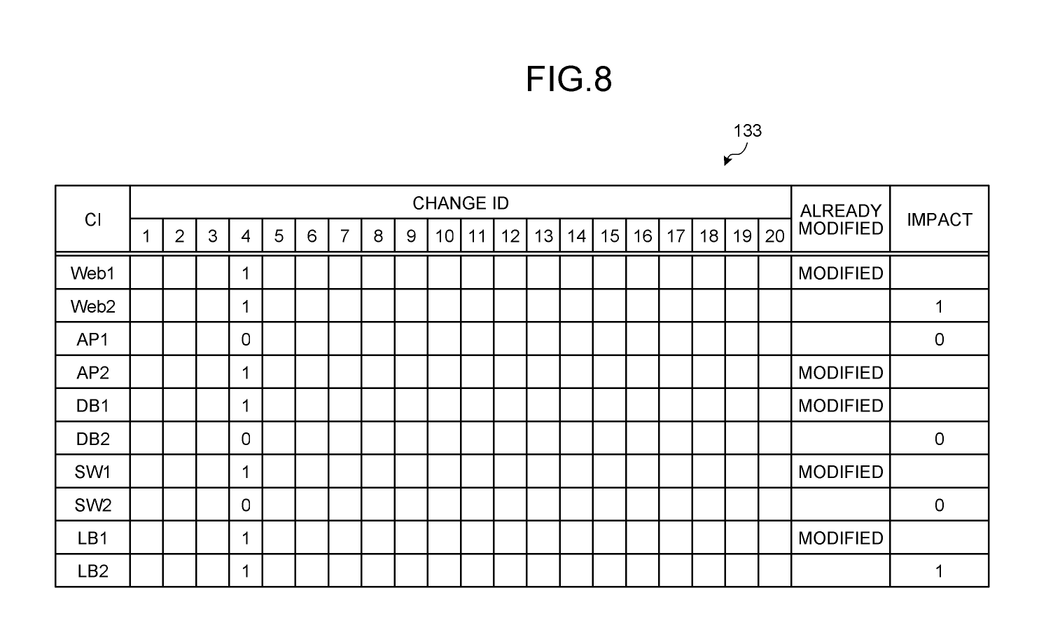

For example, it is assumed that the impact information 133 when any CI is not modified in the configuration management changes is in the state illustrated in FIG. 5A. Moreover, it is assumed that the CIs are modified by the user in order of the CIs “Web1”, “SW1”, “DB1”, “LB1”, and “AP2”. In this case, as illustrated in FIG. 8, the change impact research support device 100 updates the impact information 133. In other words, as illustrated in FIG. 8, the change impact research support device 100 narrows down the past configuration management changes to one at the point at which the CI “AP2” is modified.

In such a example, the user performs the same configuration management change as the past configuration management change in which the change ID is “4”. However, it is considered that the user wishes to perform the same configuration management change as the other past configuration management change in which the change ID is not “4”. Therefore, in the second embodiment, it will be explained about an example of a change impact research support device 200 that indicates a modification-candidate CI after considering the past configuration management change that is not modified along with the combination of CIs modified in the present configuration management change.

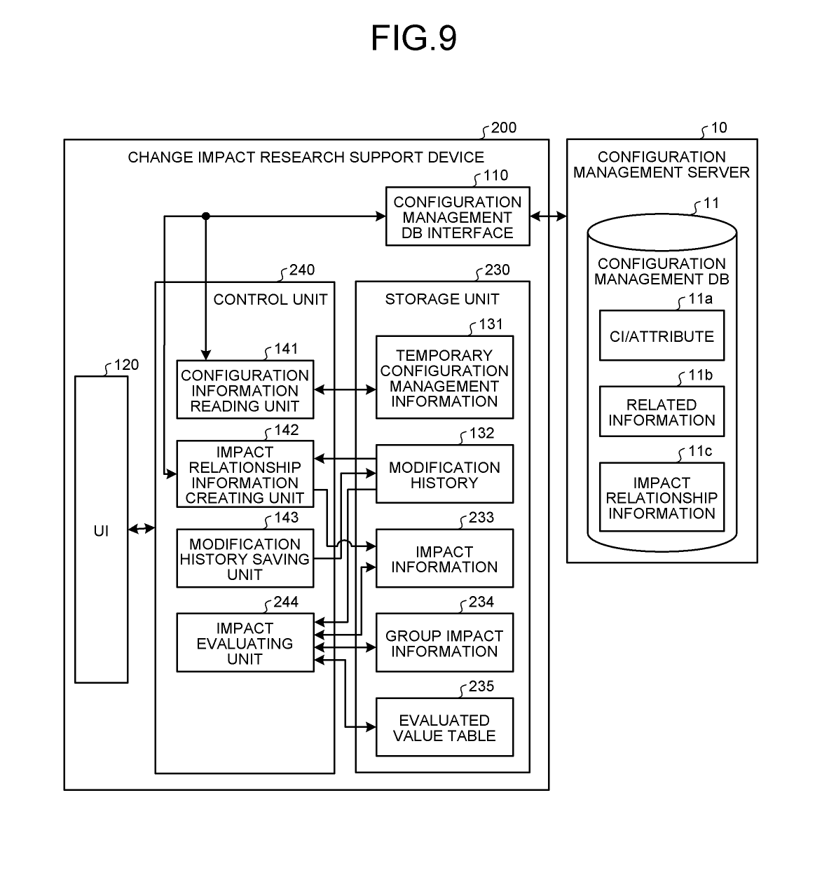

First, it will be explained about the configuration of the change impact research support device 200 according to the second embodiment. FIG. 9 is a diagram illustrating the configuration of the change impact research support device 200 according to the second embodiment. In FIG. 9, components having the same functions as those of the components illustrated in FIG. 3 have the same reference numbers, and the detailed descriptions are omitted.

As illustrated in FIG. 9, the change impact research support device 200 includes a storage unit 230 instead of the storage unit 130 and a control unit 240 instead of the control unit 140, as compared to the change impact research support device 100 illustrated in FIG. 3.

The storage unit 230 includes an impact information 233 instead of the impact information 133 as compared to the storage unit 130 illustrated in FIG. 3. Moreover, the storage unit 230 newly includes a group impact information 234 and an evaluated value table 235 as compared to the storage unit 130 illustrated in FIG. 3.

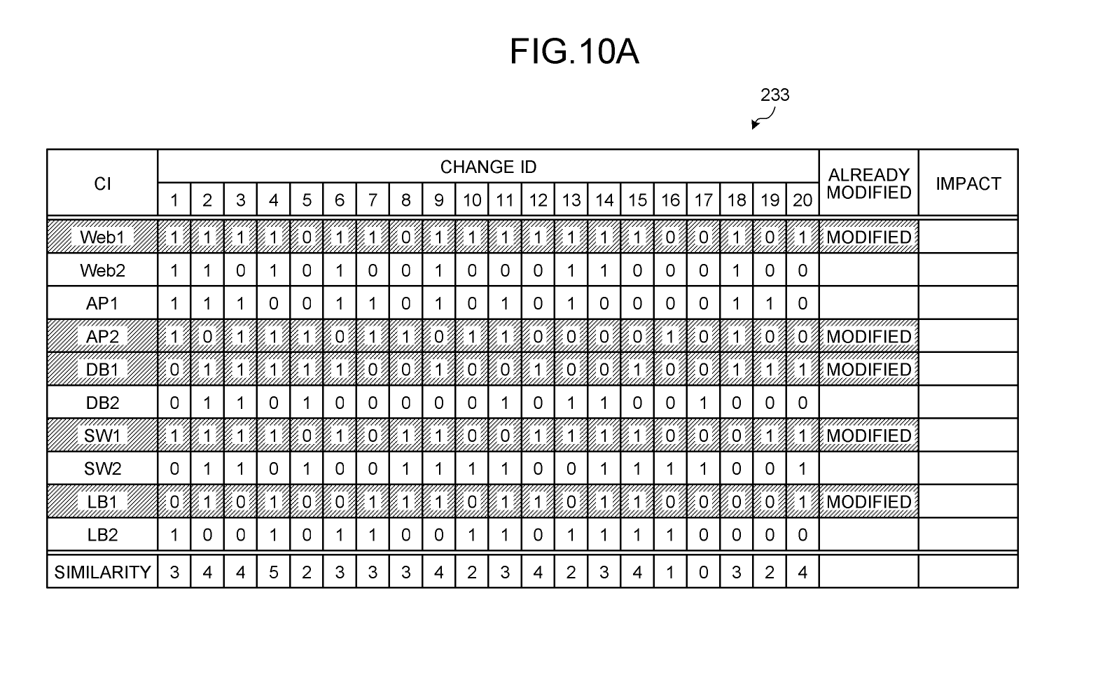

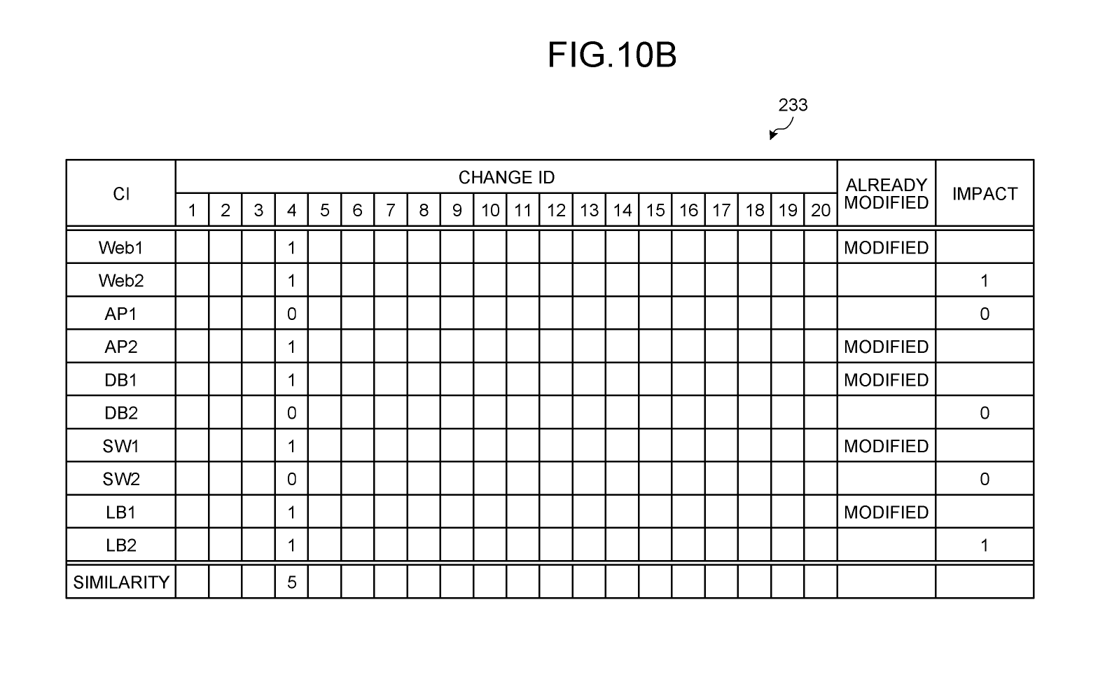

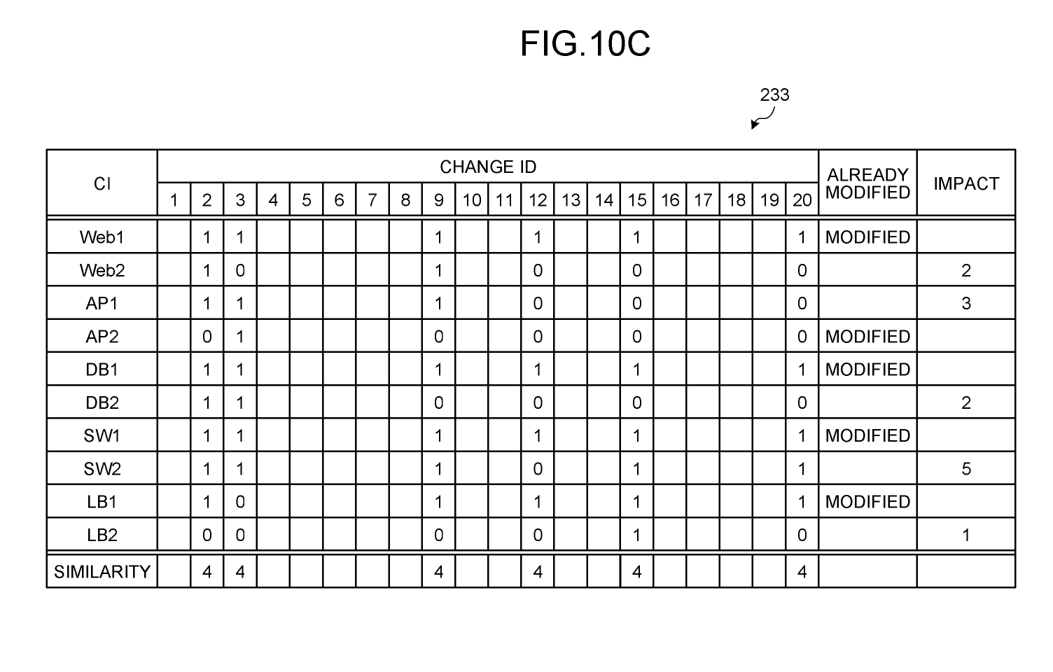

An example of the impact information 233 is illustrated in FIG. 10A. As illustrated in FIG. 10A, the impact information 233 has items such as, for example, a CI, a change ID, already-modified, and an impact, similarly to the impact information 133. Furthermore, the impact information 233 has an item such as a similarity unlike with the impact information 133.

A similarity indicates a degree by which the present configuration management change and the past configuration management change are similar to each other on the basis of a combination of CIs modified in the present configuration management change. Specifically, a similarity indicates the number of the CIs that are modified in the present configuration management change and are identical to the CIs modified in the past configuration management change.

For example, as illustrated with a slant line in the example of the impact information 233 illustrated in FIG. 10A, there is illustrated a state where the CIs “Web1”, “AP2”, “DB1”, “SW1”, and “LB1” are modified in the present configuration management change. In this case, because the three CIs “Web1”, “AP2”, and “SW1” among the CIs “Web1”, “AP2”, “DB1”, “SW1”, and “LB1” are modified in the past configuration management change in which the change ID is “1”, the similarity has “3”. Similarly, because the four CIs “Web1”, “DB1”, “SW1”, and “LB1” among the CIs “Web1”, “AP2”, “DB1”, “SW1”, and “LB1” are modified in the past configuration management change in which the change ID is “2”, the similarity has “4”.

As a result, the change impact research support device 200 can refer to various types of information stored in the similarity of the impact information 233 to recognize a degree by which the present configuration management change and the past configuration management change are similar to each other.

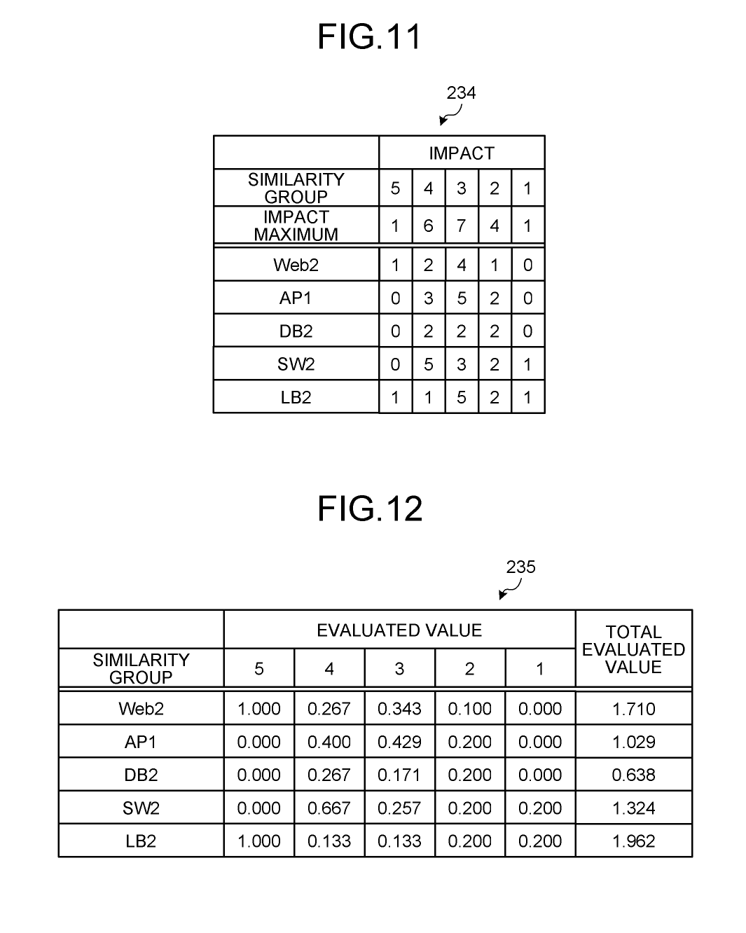

The group impact information 234 stores an impact for each the past configuration management change of which the similarity is the same. An example of the group impact information 234 is illustrated in FIG. 11. As illustrated in FIG. 11, the group impact information 234 stores an impact for each CI in association with a similarity group. Moreover, it will be explained in detail about the group impact information 234 when a process performed by the control unit 240 is explained.

The evaluated value table 235 stores an impact (hereinafter, “evaluated value”) that is weighted by a similarity, for each CI that is not modified in the present configuration management change. An example of the evaluated value table 235 is illustrated in FIG. 12. As illustrated in FIG. 12, the evaluated value table 235 stores an evaluated value for each CI in association with a similarity group. Moreover, it will be explained in detail about the evaluated value table 235 when a process performed by the control unit 240 is explained.

The control unit 240 includes an impact evaluating unit 244 instead of the impact evaluating unit 144 as compared to the control unit 140 illustrated in FIG. 3. Whenever the CI stored in the temporary configuration management information 131 is modified, the impact evaluating unit 244 updates the impact information 233, the group impact information 234, and the evaluated value table 235, and indicates a modification-candidate CI to the user.

Now, it will be explained about a modification-candidate CI indicating process that is performed by the impact evaluating unit 244 by using an example. First, it is assumed that CIs are modified by the user in order of the CIs “Web1”, “AP2”, “DB1”, “SW1”, and “LB1”. In this case, the impact evaluating unit 244 updates the impact information 233 to the state illustrated in FIG. 10A.

Specifically, as illustrated in FIG. 10A, the impact evaluating unit 244 stores “modified” in the items “already-modified” corresponding to the CIs “Web1”, “AP2”, “DB1”, “SW1”, and “LB1”. Next, the impact evaluating unit 244 updates similarities corresponding to the change IDs “1” to “20”.

Next, the impact evaluating unit 244 computes an impact for each configuration management change of which the similarity is same. Specifically, as illustrated in FIG. 10B, the impact evaluating unit 244 first extracts a configuration management change in which the similarity is “5” and the change ID is “4”. The impact evaluating unit 244 then computes an impact of the extracted configuration management change. As described above, an impact is a value that indicates a cumulative total of the past configuration management changes in which the CIs that are not modified in the present configuration management change are modified. Therefore, as illustrated in FIG. 10B, the impact evaluating unit 244 computes the impact “1” of the CIs “Web2” and “LB2” and computes the impact “0” of the CIs “AP1”, “DB2”, and “SW2”.

Next, as illustrated in FIG. 10C, the impact evaluating unit 244 extracts the configuration management changes of the change IDs “2”, “3”, “9”, “12”, “15”, and “20” of which the similarities are “4”. As illustrated in FIG. 10C, the impact evaluating unit 244 then computes the impact “2” of the CI “Web2”. This reason is that the CI “Web2” is modified in the configuration management changes of the change IDs “2” and “9”. Similarly, as illustrated in FIG. 10C, the impact evaluating unit 244 computes the impacts of the CIs “AP1”, “DB2”, “SW2”, and “LB2”.

Similarly, the impact evaluating unit 244 computes an impact for each configuration management change of which the similarity is “3”, “2”, and “1”. In this case, it is assumed that the impact evaluating unit 244 does not compute an impact for the configuration management change of which the similarity is “0”. However, the impact evaluating unit 244 may compute an impact of the configuration management change of which the similarity “is “0”. Moreover, the impact evaluating unit 244 may not compute an impact of the configuration management change of which the similarity is not more than a predetermined similarity. For example, as in this example, the impact evaluating unit 244 may not compute an impact of the configuration management change of which the similarity is not more than “0” and also may not compute an impact of the configuration management change of which the similarity is not more than “1” or “2”.

Next, the impact evaluating unit 244 updates the group impact information 234 on the basis of the computed impact. Specifically, as illustrated in FIG. 11, the impact evaluating unit 244 stores “1” in the impacts of the CIs “Web2” and “LB2” that correspond to the similarity group of which the similarity is “5”. Moreover, the impact evaluating unit 244 stores “0” in the impacts of the CIs “AP1”, “DB2”, and “SW2” that correspond to the similarity group of which the similarity is “5”. At this time, the impact evaluating unit 244 stores the number of configuration management changes belonging to the similarity group in the impact maximum of the group impact information 234. Because the similarity group of which the similarity is “5” includes only a configuration management change of the change ID “4”, the impact evaluating unit 244 store “1” in the impact maximum corresponding to the similarity group “5”.

Next, as illustrated in FIG. 11, the impact evaluating unit 244 respectively stores “2”, “3”, “2”, “5”, and “1” in the impacts of the CIs “Web2”, “AP1”, “DB2”, “SW2”, and “LB2” that correspond to the similarity group of which the similarity is “4”. Moreover, because the similarity group “4” includes six configuration management changes in which the change IDs are “2”, “3”, “9”, “12”, “15”, and “20”, the impact evaluating unit 244 stores “6” in the impact maximum corresponding to the similarity group “4”. Similarly, the impact evaluating unit 244 stores an impact and an impact maximum about the similarities “3”, “2”, and “1”.

Next, the impact evaluating unit 244 updates the evaluated value table 235 on the basis of the updated group impact information 234. Specifically, the impact evaluating unit 244 computes an evaluated value obtained by weighting an impact with a similarity for each similarity group and CI and stores the computed evaluated value in the evaluated value table 235.

Now, it will be explained about a computation technique of an evaluated value. The impact evaluating unit 244 multiplies, for each similarity group and CI, a value obtained by dividing a similarity by the similarity maximum by a value obtained by dividing an impact by the impact maximum. In other words, the impact evaluating unit 244 computes an evaluated value by calculating the following Expression (3). In this case, the term “similarity maximum” is the maximum value of similarities that are stored in the group impact information 234. In the example of the group impact information 234 illustrated in FIG. 11, because the largest similarity is “5”, the similarity maximum is “5”.

(similarity/similarity maximum)×(impact/impact maximum) (3)

As is apparent from Expression (3), the larger a similarity is, the larger an evaluated value is. Moreover, the larger an impact is, the larger an evaluated value is. In this way, the impact evaluating unit 244 computes an evaluated value obtained by weighting an impact with a similarity.

It will be explained about an evaluated value computation process that is performed by the impact evaluating unit 244 by using the example illustrated in FIG. 11. When computing an evaluated value of the CI “Web2” of the similarity group “5”, the impact evaluating unit 244 calculates (5/5)×(1/1) to obtain “1” in accordance with Expression (3). As illustrated in FIG. 12, the impact evaluating unit 244 then stores the computed “1.000” in the evaluated value corresponding to the CI “Web2” of the similarity group “5”.

Moreover, when computing an evaluated value of the CI “Web2” of the similarity group “4”, the impact evaluating unit 244 calculates (4/5)×(2/6) to obtain “0.266 . . . ” in accordance with Expression (3). As illustrated in FIG. 12, the impact evaluating unit 244 then stores the computed “0.267” in the evaluated value corresponding to the CI “Web2” of the similarity group “4”. In this case, the fourth place of the decimal fraction of the computed evaluated value is rounded off.

In this way, the impact evaluating unit 244 computes an evaluated value and stores the computed evaluated value in the evaluated value table 235. Then, the impact evaluating unit 244 sums the computed evaluated values for each the CI. Specifically, as illustrated in FIG. 12, the impact evaluating unit 244 stores the summed evaluated value for each the CI in the total evaluated value of the evaluated value table 235.

The technique for computing an evaluated value by using Expression (3) is only an example. Therefore, the impact evaluating unit 244 may compute an evaluated value by using another equation such that the larger a similarity is, the larger an evaluated value is and the larger an impact is, the larger an evaluated value is.

Then, the impact evaluating unit 244 generates a list of modification-candidate CIs in descending order of total evaluated values and controls the display of the modification-candidate CIs on the display unit. In the example illustrated in FIG. 12, the impact evaluating unit 244 controls the display of the display unit in order of the CIs “LB2”, “Web2”, “SW2”, “AP1”, and “DB2”. At this time, the impact evaluating unit 244 may control the display of the CI and the evaluated value on the display unit.

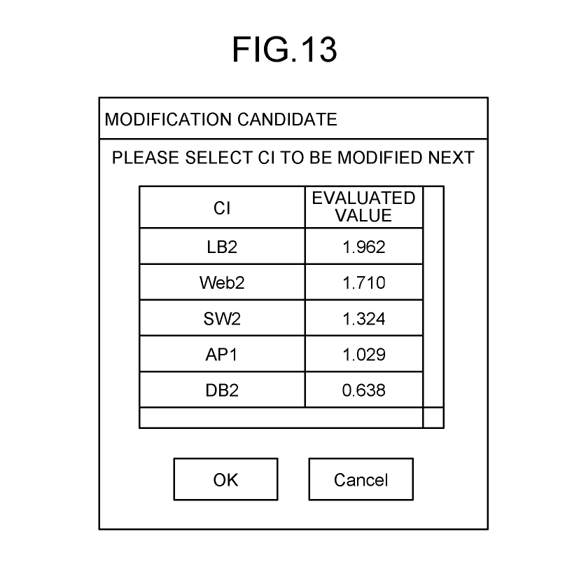

An example of a modification candidate screen that is display-controlled by the impact evaluating unit 244 illustrated in FIG. 9 is illustrated in FIG. 13. As illustrated in FIG. 13, the impact evaluating unit 244 controls the display of the CI and the total evaluated value on the display unit in descending order of total evaluated values.

Now, it is explained about the computation process of a similarity described above by using a mathematical expression. A similarity Sₙⱼ of the change IDⱼ after n-time modifications is calculated by the following Equation (4).

$${S}_{nj} = {\sum }_{k = 1}^{n} {m}_{kj} \qquad ( 4 )$$

In Equation (4), “mᵢⱼ” indicates a value (0 or 1) of a flag of the change IDⱼ of the k-th already-modified CIₖ.

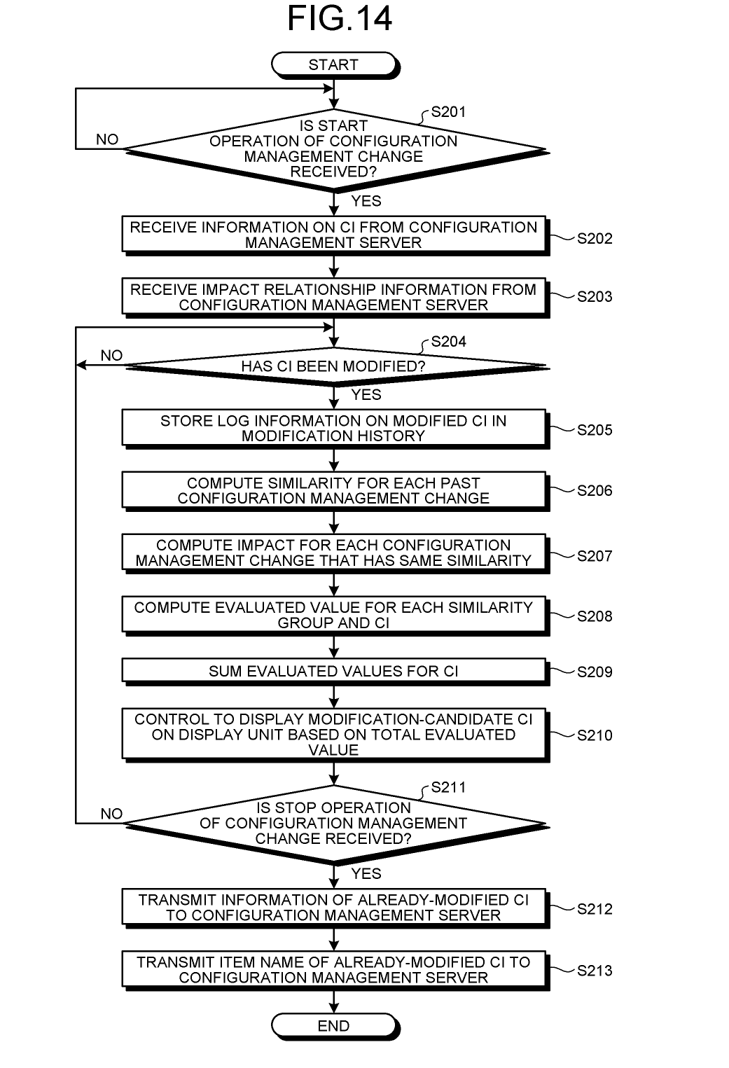

Next, it will be explained about change impact research support processing procedures that are performed by the change impact research support device 200 according to the second embodiment. FIG. 14 is a flowchart illustrating change impact research support processing procedures that are performed by the change impact research support device 200 according to the second embodiment. In this case, the descriptions for the same processing procedures (Steps S201 to S203 and S211 to S213) as the processing procedures illustrated in FIG. 7 are omitted.

As illustrated in FIG. 14, when the CI stored in the temporary configuration management information 131 is modified by using the UI 120 (Step S204: YES), the modification history saving unit 143 makes the modification history 132 store log information on the modified CI (Step S205).

Next, the impact evaluating unit 244 updates the impact information 233 and computes a similarity for each change ID (Step S206). Next, the impact evaluating unit 244 computes an impact for each configuration management change of which the similarity is the same and updates the group impact information 234 (Step S207). Next, the impact evaluating unit 244 computes an evaluated value for each similarity group and CI (Step S208). Next, the impact evaluating unit 244 sums the evaluated values for each CI (Step S209). The impact evaluating unit 244 then controls the display of a modification-candidate CI on the display unit on the basis of the computed total evaluated value (Step S210).

While the operation of stopping the configuration management change is not performed by the user by using the UI 120 (Step S211: NO), the modification history saving unit 143 and the impact evaluating unit 244 repeatedly performs the processing procedures described above (Steps S205 to S210) whenever the CI stored in the temporary configuration management information 131 is modified (Step S204: YES).

As described above, the change impact research support device 200 according to the second embodiment extracts the past configuration management changes similar to the present configuration management change from the impact relationship information DB whenever CI is modified. Next, the change impact research support device 200 computes an impact for each the configuration management change of which the similarity is the same among the extracted past configuration management changes, and computes an evaluated value that is obtained by weighting the computed impact with the similarity. The change impact research support device 200 then indicates modification-candidate CIs to the user in descending order of the computed evaluated values. As a result, the change impact research support device 200 can indicate modification-candidate CIs to the user on the basis of the past configuration management changes similar to the present configuration management change.

Moreover, because the change impact research support device 200 computes an evaluated value obtained by weighting an impact with a similarity, the higher similarity the past configuration management change has, the more easily a modification-candidate CI can be selected. As a result, the change impact research support device 200 can indicate modification-candidate CIs to the user on the basis of the past configuration management changes more similar to the present configuration management change.

As described above, the change impact research support device 200 can sufficiently decrease the number of modification-candidate CIs to be indicated to the user.

It should be noted that the change of configuration management information does not necessarily mean that the absolute same modification as the configuration management change performed in past times is performed. In general, the modification similar to the configuration management change performed in past times is performed in many cases. For example, when a change of “adding a Web server to an IT system” occurs, (1) the addition of a Web server, (2) the change of another server connected to the Web server, and the like are generally performed. Therefore, it is considered that a user can use the technique without inconvenience even in the change impact research support device 100 according to the first embodiment. Because of this, the same change impact research support device may perform the change impact research support process performed by the change impact research support device 100 according to the first embodiment and the change impact research support process performed by the change impact research support device 200 according to the second embodiment. In this case, the same change impact research support device may make the user select which of the change impact research support processes is performed. As a result, when a configuration management change similar to the configuration management change performed in past times is clearly performed, the user can select a process in such a manner that the change impact research support process performed by the change impact research support device 100 according to the first embodiment is performed. Moreover, when it is uncertain whether a configuration management change similar to the configuration management change performed in past times is performed, the user can select a process in such a manner that the change impact research support process performed by the change impact research support device 200 according to the second embodiment is performed.

### [c] Third Embodiment

However, in the first and second embodiments, it has been explained about the change impact research support device disclosed in the present application. The change impact research support device disclosed in the present application may be realized by various different configurations in addition to the first and second embodiments described above. Therefore, in the third embodiment, it will be explained about another embodiment of the change impact research support device disclosed in the present application.

System Configuration 1

In the first and second embodiments, as illustrated in FIGS. 3 and 9, an example of holding the impact relationship information 11c in the configuration management server 10 has been illustrated. However, the impact relationship information 11c may be held in another server to which the change impact research support devices 100 and 200 can be connected. In other words, the CI 11a and the impact relationship information 11c may be held in different servers.

System Configuration 2

Moreover, in the first and second embodiments, as illustrated in FIGS. 3 and 9, an example that the configuration information reading unit 141 stores the CI 11a received from the configuration management server 10 in the temporary configuration management information 131 has been illustrated. However, the configuration information reading unit 141 may store the CI 11a in the temporary configuration management information 131 that is a storage area of the unit itself. For example, the configuration information reading unit 141 may store the CI 11a in a predetermined temporary storage of the configuration management server 10. At this time, when a corrective step of CI is performed by a user, the change impact research support devices 100 and 200 modify the CI stored in the temporary storage of the configuration management server 10 via the configuration management DB I/F 110.

System Configuration 3

Moreover, in the first and second embodiments, as illustrated in FIGS. 7 and 14, when an operation of starting a configuration management change is performed, an example that the impact relationship information creating unit 142 receives the impact relationship information 11c from the configuration management server 10 has been illustrated. However, after CI is first modified by a user, the impact relationship information creating unit 142 may receive only the past configuration management change in which the modified CI has been modified from the configuration management server 10. As a result, the change impact research support devices 100 and 200 can reduce an amount of data by which data streams through the network 20.

Computer that Executes Change Impact Research Support Program

The configurations of the change impact research support devices 100 and 200 illustrated in FIGS. 3 and 9 can be variously changed without departing from the scope of the invention. For example, the function of the control unit 140 of the change impact research support device 100 can be implemented as software and this can be executed by a computer to realize a function equal to the change impact research support device 100. Hereinafter, there is illustrated an example of a computer that executes a change impact research support program 1071 made by implementing the functions of the various processes units of the change impact research support device 100 with software.

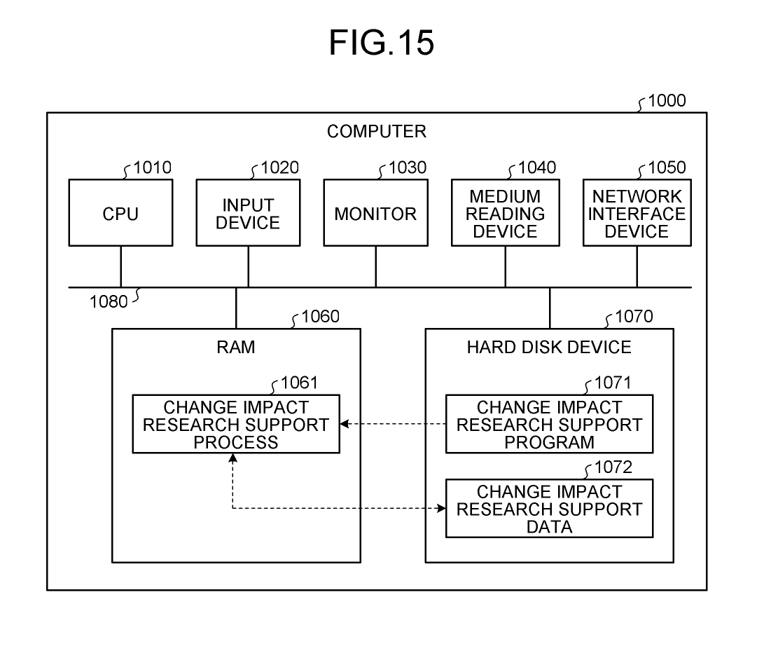

FIG. 15 is a diagram illustrating a computer 1000 that executes the change impact research support program 1071. The computer 1000 includes a CPU (Central Processing Unit) 1010 that executes various types of arithmetic processing, an input device 1020 that receives data input from a user, a monitor 1030 that displays various types of information, a medium reading device 1040 that reads a program and the like from a recording medium, a network interface device 1050 that gives and receives data to and from another computer via a network, a RAM (Random Access Memory) 1060 that temporarily stores various types of information, and a hard disk device 1070, which are connected by a bus 1080.

The hard disk device 1070 stores therein the change impact research support program 1071 that has the same function as that of the control unit 140 illustrated in FIG. 3. Moreover, the hard disk device 1070 stores therein change impact research support data 1072 that correspond to various types of data (the temporary configuration management information 131, the modification history 132, and the impact information 133) that are stored in the storage unit 130 illustrated in FIG. 3. Moreover, the change impact research support data 1072 can be appropriately distributed to be stored in other computers that are connected via the network.

The CPU 1010 reads out the change impact research support program 1071 from the hard disk device 1070 and develops the program in the RAM 1060, and thus the change impact research support program 1071 functions as a change impact research support process 1061. In this case, the change impact research support process 1061 appropriately develops information read from the change impact research support data 1072 in an area on the RAM 1060 assigned to itself and executes various types of data processing on the basis of the developed data.

The change impact research support program 1071 is not necessarily stored in the hard disk device 1070. A program stored in a storage medium such as CD-ROM may be read and executed by the computer 1000. Moreover, the program may be stored in another computer (or server) that is connected to the computer 1000 via a public line, the Internet, a local area network (LAN), a wide area network (WAN), or the like, and may be read out and executed by the computer 1000 from the other computer.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A computer-readable, non-transitory medium storing a change impact research support program for supporting a configuration management change that is a change to configuration management information including a plurality of constituent elements, the change impact research support program causing a computer to execute a process, the process comprising:
extracting, based on a combination of already-modified constituent elements that are constituent elements that are already modified in a present configuration management change that is a configuration management change that is presently performed whenever the constituent element of the configuration management information is modified, already-processed changes similar to the present configuration management change from an impact relationship information storage unit that stores therein a combination of constituent elements modified in an already-processed change for each already-processed change that is a configuration management change performed on the configuration management information in past times;
computing, for each constituent element that is not yet modified in the present configuration management change, an impact that is a cumulative total of already-processed changes in which the constituent element is modified among the already-processed changes extracted at the extracting; and
selecting a constituent element that is a modification candidate by using the computed impact.

2. The computer-readable, non-transitory medium according to claim 1, wherein
the extracting includes extracting already-processed changes similar to the present configuration management change based on a similarity that is a number of constituent elements that are modified in the already-processed changes and are identical to the already-modified constituent elements,
the computing includes computing an impact for each the already-processed change of which the similarity is the same among the already-processed changes extracted at the extracting, and
the selecting includes selecting a constituent element that is a modification candidate by using an impact obtained by weighting the computed impact with the similarity.

3. The computer-readable, non-transitory medium according to claim 1, wherein the extracting includes extracting already-processed changes including a combination of all already-modified constituent elements from the impact relationship information storage unit as the already-processed changes similar to the present configuration management change.

4. A change impact research support device for supporting a configuration management change that is a change to configuration management information including a plurality of constituent elements, the change impact research support device comprising:
an impact relationship information storage unit that stores therein, for each already-processed change that is a configuration management change performed on the configuration management information in past times, a combination of constituent elements modified in the already-processed change;
an extracting unit that extracts, based on a combination of already-modified constituent elements that are constituent elements that are already modified in a present configuration management change that is a configuration management change that is presently performed whenever the constituent element of the configuration management information is modified, already-processed changes similar to the present configuration management change from the impact relationship information storage unit; and
a modification-candidate selecting unit that computes, for each constituent element that is not yet modified in the present configuration management change, an impact that is a cumulative total of already-processed changes in which the constituent element is modified among the already-processed changes extracted by the extracting unit, and selects a constituent element that is a modification candidate by using the computed impact.

5. The change impact research support device according to claim 4, wherein
the extracting unit extracts already-processed changes similar to the present configuration management change based on a similarity that is a number of constituent elements that are modified in the already-processed changes and are identical to the already-modified constituent elements, and
the modification-candidate selecting unit computes an impact for each the already-processed change of which the similarity is the same among the already-processed changes extracted by the extracting unit and selects a constituent element that is a modification candidate by using an impact obtained by weighting the computed impact with the similarity.

6. The change impact research support device according to claim 4, wherein the extracting unit extracts already-processed changes including a combination of all already-modified constituent elements from the impact relationship information storage unit as the already-processed changes similar to the present configuration management change.

7. A change impact research support method performed by a change impact research support device for supporting a configuration management change that is a change to configuration management information including a plurality of constituent elements, the change impact research support method comprising:
extracting, based on a combination of already-modified constituent elements that are constituent elements that are already modified in a present configuration management change that is a configuration management change that is presently performed whenever the constituent element of the configuration management information is modified, already-processed changes similar to the present configuration management change from an impact relationship information storage unit that stores therein a combination of constituent elements modified in an already-processed change for each already-processed change that is a configuration management change performed on the configuration management information in past times;
computing, for each constituent element that is not yet modified in the present configuration management change, an impact that is a cumulative total of already-processed changes in which the constituent element is modified among the already-processed changes extracted at the extracting; and
selecting a constituent element that is a modification candidate by using the computed impact.
